(19) United States
(12) Patent Application Publication
(10) Pub. No.: US 2002/0184169 A1
(43) Pub. Date: Dec. 5, 2002

(54) Method and device for creating a sequence of hypotheses

(76) Inventor: David William Opitz, Missoula, MT (US)

Correspondence Address: David W. Opitz, 4600 Scott Allen Dr., Missovla, MT, 59803, US

(21) Appl. No.: 09/870,869

(22) Filed: May 31, 2001

(51) Int. Cl. G06F 15/18

(52) U.S. Cl. 706/20; 706/16

(57) ABSTRACT

The present invention provides a method and device for predicting the target class of a set of examples using a sequence of inductive learning hypotheses. The invention starts by having a set of training examples. The output to each training example is one of the target classes. An inductive learning algorithm is trained on the set of training examples. The resulting trained hypothesis then predicts the target class for many examples. A user, with the help of a computer-human interface, accepts the predictions or corrects a subset of them. Two methods are used to process the correction. The first is to combine the corrections with the training set, create a new hypothesis by training a learning algorithm, and replacing the last hypothesis in the sequence with the newly trained hypothesis. The second is take the validations and corrections for one of the target classes, create a new hypothesis with a learning algorithm using these corrections, and placing the new hypothesis as the latest in the hypothesis sequence with the purpose of refining the predictions of the sequence. This process is repeated until stopped.

### TECHNICAL FIELD

The present invention relates to a computer method and device for the problem of inductive learning, and in particular, is directed to an interactive method and device that generates a sequence of inductive learning hypotheses.

### BACKGROUND OF THE INVENTION

A system that learns from a set of labeled examples is called an inductive learning algorithm (alternatively, a supervised, empirical, or similarity-based learning algorithm, or a pattern recognizer). A teacher provides the output for each example. The set of labeled examples given to a learner is called the training set. The task of inductive learning is to generate from the training set a hypothesis that correctly predicts the output of all future examples, not just those from the training set. There is a need for accurate hypotheses. Learning from examples is applicable to numerous domains, including (but not limited to): predicting the location of objects in digital imagery; predicting properties of chemical compounds; detecting credit card fraud; predicting properties for geological formations; game playing; understanding text documents; recognizing spoken words; recognizing written letters; natural language processing; robotics; manufacturing; control, etc. In summary, inductive learning is applicable to predicting properties from any set of knowledge.

Related art algorithms differ both in their concept-representation language and in their method (or bias) for constructing a concept within this language. These differences are significant since they determine which concepts an inductive learning algorithm will induce. Experimental methods based upon setting aside a test set of instances judge the generalization performance of the inductive learning algorithm. The instances in the test set are not used during the training process, but only to estimate the learned concept's predictive accuracy.

Many learning algorithms are designed for domains with few available training instances. The more training instances available to a learning algorithm, generally the more accurate the resulting hypothesis. Recently, large sets of data with unlabelled target outputs have become available. There exists a need to assist a user in labeling the targets of a large number of appropriate examples that are used to generate an accurate learned hypothesis (which may itself consist of a set of hypotheses). Knowing which examples are the appropriate ones to label and include in a training set is a difficult and important problem. Our approach addresses this need. There also exists a need to effectively learn complex concepts from a large set of examples. Our approach addresses this need as well.

Our proposed technique is to provide an interactive approach for generating a sequence of inductive learning hypotheses, where the approach continually breaks the learning problem into simpler, well-defined tasks. In the process, validated and corrected predictions from the current sequence of hypotheses are used to create the examples for the next iteration in the sequence. These examples may need attentive labeling from a user. A user helps define a set of training instances for each learning algorithm in the sequence by indicating a sample of examples that are correct and incorrect at that point in the sequence. A computer-human interface aids the user in labeling the examples. For instance, when finding objects in digital imagery, the imagery is viewed in an interface that allows the user to digitize new objects and quickly clean up the current predictions with clean-up and digitizing tools. The examples considered by each learner in the sequence during testing and training are masked according to the classification of previous learning algorithms in the sequence.

The proposed learning approach offers numerous distinct advantages over the single pass learning approach. First and foremost, the sequence allows increased accuracy of the resulting hypotheses since each member of the sequence does not have to solve the complete learning problem; each member only has to learn a simplified subtask. Second, the proposed method helps the user label only those examples pertinent to learning, greatly simplifying the labor required to create an adequate training set. The user does not have to anticipate in advance the training instances most pertinent for learning; the examples most beneficial for learning are driven by the current errors during the learning process.

Related art algorithms that have the goal of learning from examples are not new. However our approach for using a sequence of inductive learning algorithms to break down the earning task and in the process present pertinent examples that need labeling is new and fundamentally different. There exists a need to provide a method and device for using a sequence of learning algorithms to assist in the target labeling of a large set of examples and the subsequent use of the resulting sequence of learned hypotheses for predicting the target class of future instances. This need is filled by the method and device of the present invention.

Some known art devices and methods utilize some type of inductive learning to label targets of examples to be used as a training set for learning. However, none of the known art either individually or in combination provides for a device and method of having a computer-human interface that allows a user to correct predictions of previous learners, then pass the new training set to either help retrain the previous learning algorithm, or create a new hypothesis from an inductive learning algorithm. While each of these related art devices and the particular features of each serve their particular purposes, none of them fulfill the need for solving the needs outlined above. None of the art as identified above, either individually or in combination, describes a device and method of sequential learning in the manner provided for in the present invention. These needs are met by the present invention as described and claimed below.

### SUMMARY OF THE INVENTION

The present invention overcomes all of the problems heretofore mentioned in this particular field of art. The present invention provides a technique and method for generating a sequence of inductive learning hypotheses from a set of data. The invention starts by obtaining an initial set of training examples for the inductive learning algorithm where each example in the training data is given a target class. The training examples are used to train an inductive learning algorithm. The resulting trained inductive learning algorithm hypothesis is then used to predict the targets for the training data and perhaps additional data from the set of data. For each target class, the predictions are displayed in a computer-human interface and a user supplies sample validations and corrections to the predictions, if the user is not satisfied with the accuracy of the target class. The validations and corrections are used for either (a) augmenting the training set and having an inductive learning algorithm generate a new hypothesis from the newly augmented training set, and replacing the previous learned hypothesis with this new hypothesis, or (b) creating a new hypothesis from training an inductive learning algorithm where the learning task for the learning algorithm is to correct the current predictions for a set of the target classes and this new learned hypothesis becomes the latest learned hypothesis in the sequence. This is repeated until the user is satisfied with the results.

An object of the present invention is to provide a method for labeling sets of examples and using a sequence of trained hypotheses from inductive learning algorithms that were trained on these sets of examples. The resulting sequence of learned hypotheses should generalize well to new examples. Initial tests on finding objects in imagery confirm this. Another object is to provide a mechanism that allows a user to label examples that are pertinent for learning in the resulting sequence of learning algorithms.

These and further objects and advantages of the present invention will become apparent from the following description, reference being had to the accompanying drawings wherein a preferred form of the embodiment of the present invention is clearly shown.

### BRIEF DESCRIPTION OF THE DRAWINGS

FIG. 1 is a brief flowchart of the sequential inductive-learning approach. The user starts by retrieving a set of labeled examples with N target classes to be used as a training set. The user may have to label some of these examples explicitly. The user then has the option of continually refining the predictions until determining the refinement process is complete. One refinement option is to clean up through a computer-human interface some of the predictions of the learning algorithm and then redo the previous learning step by training a learning algorithm with a training set that is improved with the results of the clean up phase. Another refinement option is to choose one of the target classes, have the user label through a computer-human interface a subset of the previous predictions for that target class, then create a training set consisting of examples of the target class the user specifies as correct or incorrect (either implicitly or explicitly). An inductive learning algorithm is trained on the resulting training set. For both of these refinement options, the purpose of this stage of learning is to correct the predictions of the previous learning algorithms.

### DETAILED DESCRIPTION OF INVENTION

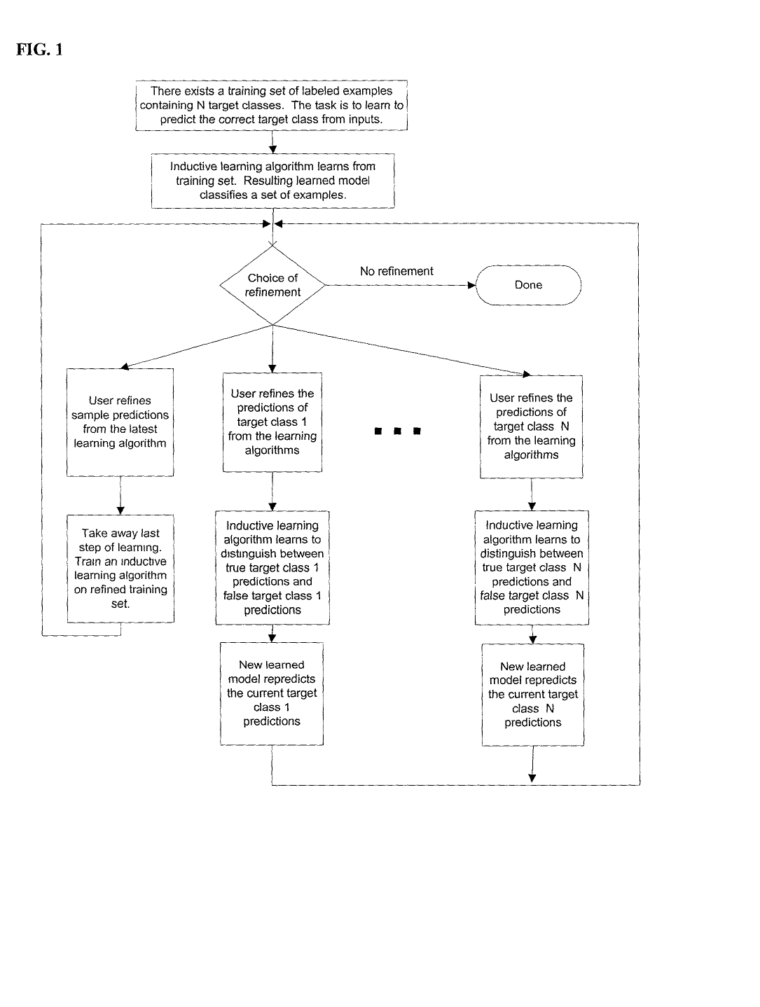

The present invention provides a method and device for providing a computer-human interface that creates a sequence of trained hypotheses from inductive learning algorithms that work together in making predictions. FIG. 1 shows how the sequence of trained hypotheses is generated. The user starts by retrieving a set of labeled examples with N target classes to be used as a training set. The user may have to label some of these examples explicitly. The user then has the option of continually refining the predictions until determining the refinement process is complete. One refinement option is to clean up through a computer-human interface some of the predictions of the learning algorithm and then redo the previous learning step by training a learning algorithm with a training set that is improved with the results of the clean up phase. Another refinement option is to choose one of the target classes, have the user label through a computer-human interface a subset of the previous predictions for that target class, then create a training set consisting of examples of the target class the user specifies as correct or incorrect (either implicitly or explicitly). An inductive learning algorithm is trained on the resulting training set. For both of these refinement options, the purpose of this stage of learning is to correct the predictions of the previous learning algorithms

The invention is as follows. A set of data is provided. The data has a desired target variable consisting of a set of target classes. The task for an inductive learning algorithm is to learn from a set of examples how to predict the target class from the other data variables, termed input variables. The result from the learning algorithm, called the learned hypothesis, is then used to predict the target class for the rest of the data. In a preferred embodiment, neural networks are utilized as the inductive learning algorithm, however, the invention can be extended to other learning algorithms such as decision trees, Bayesian learning techniques, linear and nonlinear regression techniques, instance-based and nearest-neighbor learning techniques, connectionist approaches, rule-based learning approaches, reinforcement learning techniques, pattern recognizers, support vector machines, and theory refinement learners.

At the start of the invention, the user must supply sample target classifications from data if the current data set does not include enough such samples. A learned hypothesis is then created, by using the initial set of training examples to train an inductive learning algorithm. The resulting trained hypothesis from this learning algorithm is then used to predict the targets for the training data and additional data from the data set. Predictions on the data set are displayed in a computer-human interface and a user supplies sample corrections to the predictions. The user then has the option of continually refining the predictions until determining the refinement process is complete. One refinement option is to clean up through a computer-human interface some of the predictions of the learning algorithm and then redo the previous learning step by training an inductive learning algorithm on a training set augmented from this clean up phase. Another refinement option is to correct the errors of one of the target classes with another round of learning. This is done by having the user create, from the current predictions and through a computer-human interface, a training set consisting of examples the user specified as currently being either correct or as one of the other target classes. An inductive learning algorithm is trained on the resulting training set for one target class. This learning algorithm becomes the next learned hypothesis in the sequence. For both of these refinement options, the purpose of this stage of learning is to correct the predictions of the previous learning algorithms on the specified target class.

Various changes and departures may be made to the invention without departing from the spirit and scope thereof. Accordingly, it is not intended that the invention be limited to that specifically described in the specification or as illustrated in the drawings but only as set forth in the claims. From the drawings and above-description, it is apparent that the invention herein provides desirable features and advantages. While the form of the invention

What is claimed and desired to be secured by United States Letters Patent is:

1. A method for generating a sequence of hypotheses, comprising:
providing a training set of examples to be classified, said training set of examples having an output variable to be predicted containing N target classes;
providing a learning means for receiving a subset of said training set of examples and generating an initial hypothesis therefrom, said initial hypothesis predicting a target class for each of said training set of examples;
providing a correction means for creating a correction set of examples via a computer-human interface wherein a user validates and corrects the target class of a set of examples beyond said training set of examples, said correction set of examples having an output variable to be predicted containing up to said N target classes;
providing a retraining means for said learning means to receive a subset of said correction set of examples and a subset of said training set of examples, and generating a retraining hypothesis therefrom;
providing a refinement means of appending the end of a sequence of hypotheses with said retraining hypothesis creating a resulting sequence of hypotheses, said resulting sequence of hypotheses predicting the target class of each example;
providing a refinement means of replacing the last hypothesis of said sequence of hypotheses with said retraining hypothesis and the resulting sequence of hypotheses predicting the target class of each example; and
repeating the said correction means, said retraining means, and said refinement means process.

2. The method for generating a sequence of hypotheses of claim 1 wherein said learning means further comprises providing an inductive learning algorithm approach.

3. The method for generating a sequence of hypotheses of claim 1 wherein said learning means further comprises providing a neural network approach.

4. The method for generating a sequence of hypotheses of claim 1 wherein said learning means further comprises providing a decision tree approach.

5. The method for generating a sequence of hypotheses of claim 1 wherein said learning means further comprises providing a Bayesian learning approach.

6. The method for generating a sequence of hypotheses of claim 1 wherein said learning means further comprises providing a linear or nonlinear regression approach.

7. The method for generating a sequence of hypotheses of claim 1 wherein said learning means further comprises providing an instance-based learning approach.

8. The method for generating a sequence of hypotheses of claim 1 wherein said learning means further comprises providing a nearest-neighbor learning approach.

9. The method for generating a sequence of hypotheses of claim 1 wherein said learning means further comprises providing a connectionist learning approach.

10. The method for generating a sequence of hypotheses of claim 1 wherein said learning means further comprises providing a rule-based learning approach.

11. The method for generating a sequence of hypotheses of claim 1 wherein said learning means further comprises providing a pattern recognizer learning approach.

12. The method for generating a sequence of hypotheses of claim 1 wherein said learning means further comprises providing a reinforcement learning approach.

13. The method for generating a sequence of hypotheses of claim 1 wherein said learning means further comprises providing a support vector machine learning approach.

14. The method for generating a sequence of hypotheses of claim 1 wherein said learning means further comprises providing an ensemble learning approach.

15. The method for generating a sequence of hypotheses of claim 1 wherein said learning means further comprises providing a theory-refinement learning approach.

16. The method for generating a sequence of hypotheses of claim 1 wherein said retraining means further comprises providing a method of combining the said training set of examples with the said correction set of examples.

17. A device, for running on a computer, for generating a sequence of hypotheses, comprising:
an input means for receiving a training set of examples, said training set of examples having an output variable to be predicted containing N target classes;
a learning means for receiving a subset of said training set of examples and generating an initial hypothesis therefrom, said initial hypothesis predicting a target class for each of said training set examples;
a correction means for creating a correction set of examples via a computer-human interface wherein a user validates and corrects the predicted target class of a set of examples beyond said training set of examples, said correction set of examples having an output variable to be predicted containing up to said N target classes;
a retraining means for said learning means to receive a subset of said correction set of examples and a subset of said training set of examples, and generating a retraining hypothesis therefrom;
a refinement means of appending the end of a sequence of hypotheses with said retraining hypothesis creating a resulting sequence of hypotheses, said resulting sequence of hypotheses predicting the target class of each example;
a refinement means of replacing the last hypothesis of said sequence of hypotheses with said retraining hypothesis and the resulting sequence of hypotheses predicting the target class of each example; and
a repeating means, for repeating the said correction means, said retraining means, and said refinement means process.
